(19) United States
(12) Patent Application Publication
(10) Pub. No.: US 2007/0043606 A1
(43) Pub. Date: Feb. 22, 2007

(54) Identifying and validating survey objectives

(75) Inventors: Ravi Kothari, New Delhi (IN); Yogish Sabharwal, New Delhi (IN); Raghavendra Singh, New Delhi (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/207,965

(22) Filed: Aug. 19, 2005

(51) Int. Cl. G06F 17/30

(52) U.S. Cl. 705/10

(57) ABSTRACT

Historical data accumulated during routine business operations is analyzed to prepare a ranked list of prospective objectives for a survey. Specified relationships are used in conjunction with relationships inferred from the historical data. Collectively, these relationships are referred to as the model. Deviation of the current data or a subset of the data from the model, and the extent of this deviation, is used to prepare a ranked list of prospective objectives for a survey. Surveys focusing on one or more of these objectives are prepared for obtaining business intelligence. A list of prospective objectives of a survey is validated against the model to design more informative surveys.

### FIELD OF THE INVENTION

The present invention relates to identifying and validating survey objectives.

### BACKGROUND

Surveys are a popular method of obtaining business intelligence. Customer's preferences, pain points and future intent are examples of common forms of business intelligence that can be gathered using surveys. The objective of a survey is often referred to as a survey goal, and gathering business intelligence using surveys typically consists of several steps—the sequential framework of: “Goal”, “Who”, “What”, “How” and “Analysis” is often used. The “Goal” step defines the objectives of the survey (what is to be learnt from the survey exercise), the “Who” step defines who is going to be surveyed, the “What” step involves creating a set of questions (and often determining the sequence in which these questions are asked to minimize ordering bias), the “How” step defines the modality of administering the survey (telephone-based, web-based, paper-based), and the “Analysis” step defines what is done to the responses to obtain the relevant business intelligence.

Typically, a person or organization commissioning the survey specifies the “Goal”, and then those with specialized skills design the content (“What”) of the survey. As an example, an online marketing manager may wish to determine the cause of a disproportionate number of abandoned shopping carts on a retailer's web site. Identifying events or indicators that can serve as “Goals” of a survey is not an easy task, and is often based on heuristics gleaned from experience. On the other hand, the cost of deploying a survey can be significant, both in terms of tangible costs (equipment, manpower and so on), and intangible costs (such as antagonizing the respondents, who are also existing or prospective customers by asking lengthy and uninteresting surveys).

A considerable amount of literature exists on related aspects of surveys. For example, U.S. Pat. No. 4,603,232 issued Jul. 29, 1986 to NPD Research, Inc. discloses a method for dissemination and collation of personalized surveys. More recently, U.S. Patent Application No. 20030195793 published Oct. 16, 2003 in the name of Vivek Jain et al. discloses a system for automated online design and analysis of marketing research activity (including surveys) and data. This publication also discloses the use of historical data for personalizing surveys for a selected set of target customers.

International Publication No. WO2004/53754, published Jun. 24, 2004 in the name of See-Why Software Limited, describes a computer system that allows business people to better monitor their business performance. The computer system described in this publication allows business people to analyze and filter the business data using set goals, metrics, rules, and so on, blending historical data with current data. Future business performance can be predicted, and the likelihood of achieving a particular goal determined without using manual analysis. “Rules” are used, which are business conditions that hold particular significance for the business. These rules can be user specified; alternatively, complex rules can be derived from the historical data using artificial intelligence and statistical techniques. “Alerts” are defined as actions triggered by the rules. For example, there may be a rule named “reorder”, which triggers an alert to a purchasing manager if inventory stock falls below minimum order quantity. Alerts are triggered every time an event occurs.

Separately, there exist several broad guidelines to help survey designers produce better designs. These guidelines are typically concerned with how to design a survey such that the survey is unbiased, comprehensible, easy to interact with, and so on. While this information is no doubt useful, there exists a need for improved methods and systems for designing surveys.

### SUMMARY

Historical data accumulated during business operations is analyzed, with the result that prospective survey objectives can be identified and, if need be, ranked by priority. Functional relationships are parameterized relationships relating one or more controllable variables with one or more observable variables. Functional relationships are determined as a basis for forming respective nominal models for expected behavior. One or more parameters associated with each functional relationship are estimated based upon the values of the historical data for the controllable and observable variables. These functional relationships, along with any user specified relationships, comprise the nominal models which encapsulate the expected behavior. A nominal model, once constructed, can subsequently be used to provide the nominal output corresponding to an input for which the output is observed. One or more metrics capturing the degree to which values of the observed data depart from corresponding values predicted by the nominal model are then used as a basis for identifying and prioritizing prospective survey objectives. Identification of the objectives is based on the controllable and observable variables of the corresponding nominal model. Prioritization of the objectives is based upon the relative value of the computed metrics.

Conversely, similar techniques can be used to verify an existing survey objective or an objective arrived at using some other approach. In this situation, a nominal model is again formed between the controllable and observed variables and an associated metric is computed. For each of the one or more nominal models, this metric, as before, represents a degree of departure of the values of the observed data from the corresponding values predicted by the nominal model. Verification of the objectives is based upon the relative value of the computed metrics.

A list of survey objectives can be prepared, and ranked by priority. Surveys focusing on one or more of these objectives can then be prepared for obtaining business intelligence. Further, a list of prospective survey objectives can be validated to design more informative surveys.

### DESCRIPTION OF DRAWINGS

FIG. 1 is schematic flow diagram of steps involved in a procedure for identifying survey objectives, as described herein.

FIG. 2 is a schematic representation of a computer system suitable for performing the techniques described herein.

FIG. 3 is a graph depicting an example of the sales observed (observable variable) at different discount levels (controllable variable) for a retail product.

### DETAILED DESCRIPTION

A means of automatically identifying a ranked list of prospective survey objectives is described herein based on analysis of data collected during routine business operation, referred to as historical data. Historical data not only comprises data, stored by a business, relating to business transactions, but also supplementary data that is deemed relevant. As an example, in the case of a web-based retail business, historical data may include past transaction logs, promotion records, pricing details, web logs, supply side related information, email exchanges, and so on. Supplementary data relates to external factors and may, for example, concern daily temperatures, or other details relating to prevailing weather conditions. Weather conditions—and other supplementary data—may in many cases have a likely or actual bearing on business transactions that warrants further investigation.

Different variables are recorded in the historical data, such as price, sales, weather conditions, and so on. The historical data can be considered as reflecting various inter-relationships that exist between these variables. Some relationships—at least in some basic form—are clear. Many relationships may however not be immediately apparent, or may indeed be counter-intuitive. One may expect, for example, that promotions and discounts, or other price-reduction mechanisms increase the quantity sold of the promoted item. The implications for the quantity sold of the promoted item are less apparent when several other products are also promoted. The situation becomes further complicated when other variables (besides just the price) vary. Detecting or discerning such relationships can be particularly difficult, and many relationships may escape entirely unnoticed, or are improperly or imperfectly grasped.

Discovering unrecognized relationships, as outlined above, is deemed desirable. Survey objectives can be identified by the non-conformance of observed data with generally recognized or perceived relationships. Continuing with the example described above, a manager—upon observing that sales are decreasing despite a promotion—may conduct a survey with the objective of discovering why the sales to promotion relationship is not being observed, as expected.

A procedure is used to determine a set of prospective objectives of a survey based on historical data. First, the historical data is analyzed to “discover” various inter-relationships between the variables in the historical data. Then, further analysis determines whether or not the historical data conforms to these discovered relationships. If the data does not conform, and the degree of non-conformance is high, then the relationship under investigation can be considered as a basis for formulating a prospective survey objective.

Further, if a manager intuitively or otherwise arrives at a survey objective, the techniques described herein can be used to assess whether or not the proposed survey yields new information. To estimate the utility of a proposed survey, the historical data is analyzed to discover the relationship between the variables specified by the survey objective. If the observed data conforms to the discovered relationship then the proposed survey does not provide any new information. On the other hand, if the data does not entirely conform to the relationship then the degree of non-conformance may be used as a measure of how much information the proposed survey may provide. This measure may be useful, as a manager can then design and schedule a survey based on the priority associated with the likely information content that may result.

The foregoing description makes the following points, which are described below.
(a) One or more nominal models capture the inter-relationships between controllable and observable variables. Such nominal models will be inferred from the historical data, and may be augmented with domain-specific knowledge.
(b) The departure of the observed behavior (in a subset of the historical data) from the nominal model is used to identify potential prospective survey objectives. The degree of departure may alternatively be used as a measure of the utility or expected information content of a proposed Survey goal.
(c) Given a survey goal, a nominal model between the variables identified by the goal may be inferred. The expected information content of the proposed survey can then be determined by measuring the degree of departure. Hence the objective may be validated for cases in which the manager has specified a survey objective.

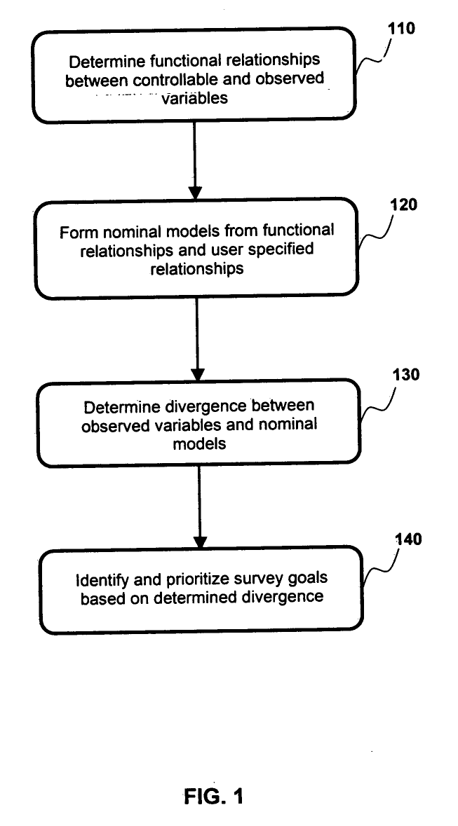

FIG. 1 shows a schematic flow diagram of the steps involved in identifying prospective survey objectives. All functional relationships between a set of controllable and observed variables are determined in step 110 from the historical data. For example, the functional relationship between discounting as the controllable variable and sales as the observed variable may be determined in step 110.

Nominal models are then formed, in step 120, based upon the functional relationships determined in step 110, as well as user specified relationships if such user specified relationships exist. Such user specified relationships may include relationships derived from business intelligence, or a model that captures part of the behavior of a variable where the variable deviates from the average.

Having generated nominal models, the divergence or degree of departure between observed variables and the prediction corresponding nominal models is determined in step 130. Finally, survey objectives can be identified and prioritized in step 140 based upon the divergence determined in step 130.

A converse procedure is followed in the case in which an existing or proposed survey objective is verified or, in other words, assessed as to its suitability. Similar steps 120 and 130 are performed, but on the basis of a functional relationship between controllable variables and observable variables that follow from the existing or proposed survey objective. A final evaluation is then made by the user as to how well the degree of departure determined in step 130 between observed data and prediction from the nominal model.

Particular steps described in the above procedure, forming the nominal model, and determining the degree of departure of observed behavior from the nominal model, are described in further detail below.

Forming Functional Relationships and Nominal Models

A functional relationship between controllable and observed variables is inferred in step 110 from historical data. Much of this historical data may conform to “expected” behavior while other data may reflect “unexpected” behavior. Ideally, the functional relationship is induced from that portion of the historical data that conforms to expected behavior; however, the “expected” behavior may not be known.

The inter-relationships manifested by much of the historical data are hypothesized as the “expected” behavior. A smaller proportion of the historical data may deviate from expected behavior and the challenge is to find this expected behavior and any deviation from this behavior.

Robust estimation techniques may be used to find the inter-relationships between chosen controllable and observed variables. Robust estimation techniques are not overly affected by “outliers”, and thus allow parameters of a functional relationship to be induced. Further details concerning relevant robust estimating techniques can be obtained from P. J. Rousseeuw, “Least Median of Squares Regression,’ Journal of the American Statistical Association, Vol. 79, pp. 871-880, 1984, and R. Kothari, “Robust Regression Based Training of ANFIS,” Proc. 18th International Conference NAFIPS, pp. 605-609, 1999. The contents of these two references are incorporated herein in their entirety.

In general, there are multiple controllable variables and multiple observed variables. For each observed variable, feature selection methods may be used to find the controllable variables that affect the observed variable being considered. Further details concerning feature selection methods can be obtained from M. Dong, and R. Kothari, “Feature Subset Selection Using a New Definition of Classifiability,” Pattern Recognition Letters, Vol. 24, pp. 1215-1225, 2003. The content of this reference is incorporated herein in its entirety.

Robust regression (or other similar techniques) is then used to find the functional relationships between the chosen variables. Thus, the regression of the chosen controllable variables (marketing variables like promotions, for instance in the case of a retail store) against the corresponding observed variable (such as sales) is used to formulate one functional relationship. Multiple functional relationships may similarly be inferred based on other observed variables and corresponding controllable variables.

Functional relationships may be supplemented by additional user specified information (e.g., another model that captures only that part of the behavior that arises from deviation from the average, or inputs from the user, or business intelligence etc).

The functional relationship, for which parameters are estimated in step 110, along with user specified relationships, comprise a nominal model. The nominal model represents the overall model and specifies how the observable variables change with a change in the controllable variables. If no additional input is available, the nominal model is the same as the functional relationship. The nominal model, which is formed in step 120, thus defines the expected behavior.

Determining the Degree of Departure of Observed Behavior from the Nominal Model

Detecting prospective objectives for the survey are determined by finding the degree of “misfit”, or departure, between the nominal model and the observed historical data. To make the determination of the departure robust, neighboring data points are considered in order to determine whether such neighboring points display similar departure from the nominal model. The degree of departure, or divergence, between the nominal model and the observed data is then used to assign a score. One example of a scoring function or cost function is presented in Equation [1] below.

$${S}_{i} ( x ) = {\sum }_{j ∈ {N}_{i}} {[ y ( {x}_{j} , θ ) - Y ( {x}_{j} ) ]}^{2} \qquad [ 1 ]$$

wherein Sᵢ(x) is the score reflecting the degree of departure of point i from the nominal model, xⱼ is vector of the jth instance of the controllable variable, y(xⱼ,θ) is the predicted output obtained from the nominal model, θ corresponds to the model parameters, Y(xⱼ) is the observed response and Nᵢ denotes points in the neighborhood of vector xᵢ. A normalized scoring function may also be used, such as one that normalizes based on the number of variables.

The scores Sᵢ(x) allow ranking the discrepancies found between the nominal model and the observed variables. Observed variables resulting in the higher scores Sᵢ(x) are good candidates for identifying survey objectives.

Identifying Survey Objectives Based on Divergence

The survey objectives are identified by the controllable variables and the corresponding observed variables. A graphical user interface (GUI) may be used to communicate the controllable variables, the corresponding observed variables and the extent of deviation to the user in suitable format. Prospective objectives for a survey can be selected as required.

Determining Functional Relationship from a Survey Objective

For validation of survey objectives, one or more survey objectives are provided as input. Each survey objective is specified using one or more controllable variables and observed variables, which are present in the historical data. The functional relationship between these variables is then determined from the historical data using the techniques described above.

Computer Hardware

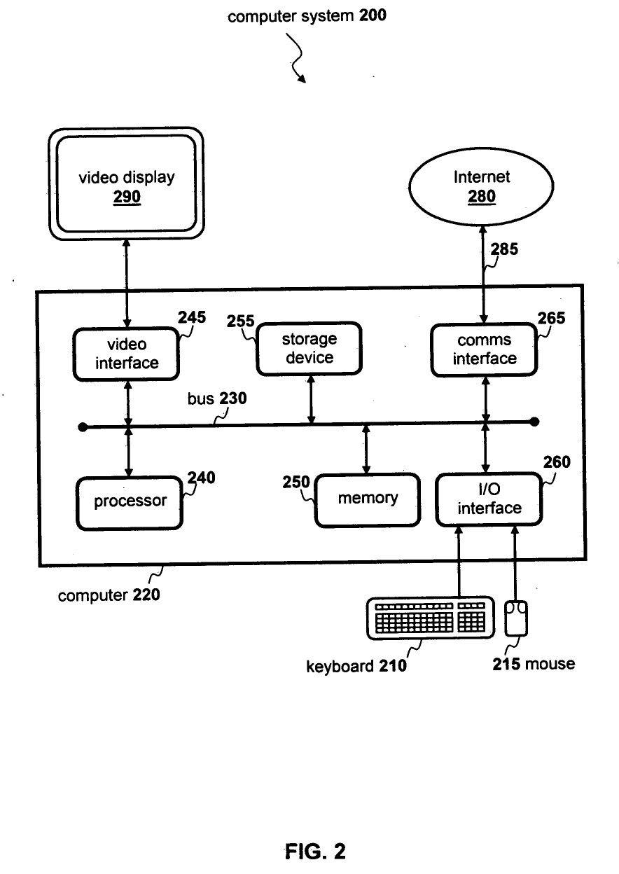

FIG. 2 is a schematic representation of a computer system 200 suitable for executing computer software programs for identifying and validating survey objectives, as described herein. Computer software programs execute under a suitable operating system installed on the computer system 200, and may be thought of as a collection of software instructions for implementing particular steps.

The components of the computer system 200 include a computer 220, a keyboard 210 and mouse 215, and a video display 290. The computer 220 includes a processor 240, a memory 250, input/output (I/O) interface 260, communications interface 265, a video interface 245, and a storage device 255. All of these components are operatively coupled by a system bus 230 to allow particular components of the computer 220 to communicate with each other via the system bus 230.

The processor 240 is a central processing unit (CPU) that executes the operating system and the computer software program executing under the operating system. The memory 250 includes random access memory (RAM) and read-only memory (ROM), and is used under direction of the processor 240.

The video interface 245 is connected to video display 290 and provides video signals for display on the video display 290. User input to operate the computer 220 is provided from the keyboard 210 and mouse 215. The storage device 255 can include a disk drive or any other suitable storage medium.

The computer system 200 can be connected to one or more other similar computers via a communications interface 265 using a communication channel 285 to a network, represented as the Internet 280.

The computer software program may be recorded on a storage medium, such as the storage device 255. Alternatively, the computer software can be accessed directly from the Internet 280 by the computer 220. In either case, a user can interact with the computer system 200 using the keyboard 210 and mouse 215 to operate the computer software program executing on the computer 220. During operation, the software instructions of the computer software program are loaded to the memory 250 for execution by the processor 240.

Other configurations or types of computer systems can be equally well used to execute computer software that assists in implementing the techniques described herein.

### EXAMPLE

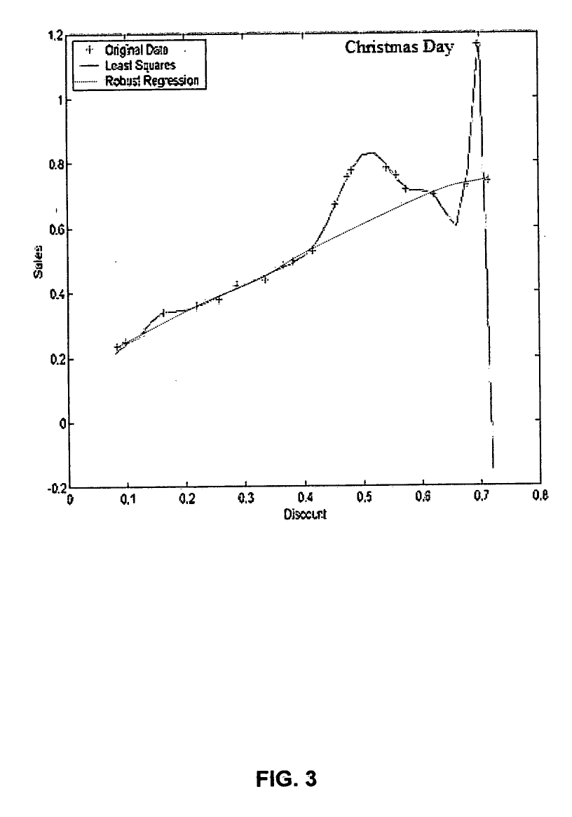

FIG. 3 is a graph that depicts the revenue realized from the sale of a product at various levels of discounting. One may expect, in an a priori manner, that the sales may increase with increasing levels of discounts, and that any increases are proportional to the level of discount. In this particular case, the functional relationship involves the controllable variable of “Discount”, and an observed variable of “Sales”.

The observed data shown in FIG. 3 includes some outliers. The outliers are data points not following the least squares line illustrated. A functional relationship between the sales as the observed variable and discounting as the controllable variable is identified using robust regression techniques, and is indicated as a dotted line in FIG. 3. The use of non-robust regression type methods, such as those based on least squares (as indicated by the solid line in FIG. 3), do not detect this type of relationship. Hence, robust regression is less sensitive to outliers, and is therefore more useful for determining functional relationships, than least squares. Furthermore, robust regression makes better allowance for observed data which contains departures from a “true” relationship between the controllable and observed variables.

The example above also identifies the particular discount level and associated sales on Christmas Day. If this knowledge is available then the Christmas Day sales can no longer be considered as outlier (one expects sales to jump on Christmas Day). The nominal model now comprises of the functional relationship as identified by the robust regression technique and additional information in the form of identification of Christmas Day sales by the user.

Having determined the nominal model in the specific example, the degree to which the observed data diverge from what is predicted from the nominal model is determined. The degree of divergence of observed behavior from the nominal model is determined, or calculated, using an appropriate scoring function or cost function, such as that presented as Equation [1] above. The outliers contribute comparatively more to the degree of divergence.

The extent of divergence of the data from the robust regression based nominal model is used to determine, rank and validate prospective survey objectives. Other nominal models may also be identified. The survey objective of “the effect of discounting on sales” is then ranked along with such other nominal models based on their comparative degrees of divergence.

Applications

Consider a first case in which the observed variable is the sales of a product. The various parameters are the promotions of the product and its competing products and display of the product (how visible the product is in terms of advertisements, and so on). According to historical data analysis, given a level of promotion of product and competing products, the sales of the product is expected to go up with the advertisement visibility of the product. The store advertises the product, but does not observe an increase in sales; hence, the sale-advertisement model does not fit the data. The manager can then design a survey that queries the relationship between sales and advertisements, and also measures the advertisement quality as perceived by the user. Normal business operations do not store the perceived advertisement quality unless explicitly obtained by a survey.

Consider a second case concerning computer sales in different configurations (for example, one configuration with a dial-up modem and one without). A shift is observed in the sales of the different configurations. A focused survey objective which relies on the differences in the configurations can be identified to understand this changing trend (more users opting for the configuration without a dial up modem due to increased availability of DSL—digital service loop).

Consider a third case of an airline managing demand for flights. Airline ticket sales for particular routes may be well modeled by seasonality, prevailing economic conditions etc. The model may however not predict the current sales in the case of extraordinary events, such as “news” items such as endemic disease, natural disaster, or political unrest. Relevant news data and transaction data can be time analyzed to form a relationship between the event and the sales. Sufficiently high confidence in the occurrences of the event and the determined outliers implies a direct relationship between the news data and the sales. However, if the confidence is moderate but not sufficiently high, then a Survey can be constructed with the Objective that identifies how the event affects the business operations. For example in case of an internet virus attack users may not be able to log onto the airline's web-site sales channel.

Conclusion

Various alterations and modifications can be made to the techniques and arrangements described herein, as would be apparent to one skilled in the relevant art.

1. A method for identifying survey objectives, said method comprising:
estimating parameters of relationships between variables of historical data, wherein each relationship relates at least one observable variable to at least one controllable variable;
computing, for each of the relationships, a metric representing a degree of departure between values of said historical data and corresponding values predicted by said estimated parameters of the relationship;
ranking each of the relationships based upon the computed metric representing the degree of departure of the values of the historical data and the corresponding values predicted by the estimated parameters of the relationship; and
identifying at least one survey objective based upon the controllable and observed variables of the ranked relationships.

2. The method as claimed in claim 1, wherein said relationship further includes at least one user specified relationships.

3. The method as claimed in claim 1, wherein the metric for each of the relationships is computed based upon a scoring function that represents a sum-of-squares error between the historical data and the corresponding values.

4. The method as claimed in claim 3, further comprising ranking the relationships based upon the relative values of computed metrics.

5. The method as claimed in claim 1, wherein the estimated parameters of the relationships are estimated using robust regression techniques.

6. The method as claimed in claim 1, wherein the historical data comprises data relating to business transactions, and supplementary data relating to external factors.

7. A method of verifying at least one survey objective comprising:
identifying from said at least one survey objective controllable and observed variables;
forming a relationship between said controllable and observed variables from historical data;
estimating, for each of the relationships, parameters of the relationship based upon values of the historical data for variables related by the relationship;
computing, for each of the relationships, a metric representing a degree of departure between the values of the historical data and the corresponding values predicted by the estimated parameters of the relationship; and
assessing a utility of at least one survey objective based upon the metrics computed for the relationships.

8. A program storage device readable by machine, tangibly embodying a program of instructions executable by the machine to perform a method for identifying survey objectives, said method comprising:
estimating parameters of relationships between variables of historical data, wherein each relationship relates at least one observable variable to at least one controllable variable;
computing, for each of the relationships a metric representing a degree of departure between values of said historical data and corresponding values predicted by said estimated parameters of the relationship;
ranking each of the relationships based upon the computed metric representing the degree of departure of the values of the historical data and the corresponding values predicted by the estimated parameters of the relationship; and
identifying at least one survey objective based upon the controllable and observed variables of the ranked relationships.

9. The program storage device as claimed in claim 8, wherein said relationship further includes at least one user specified relationships.

10. The program storage device as claimed in claim 8, wherein the metric for each of the relationships is computed based upon a scoring function that represents a sum-of-squares error between the historical data and the corresponding values.

11. The program storage device as claimed in claim 10, wherein said method further comprises ranking the relationships based upon the relative values of computed metrics.

12. The program storage device as claimed in claim 8, wherein the estimated parameters of the relationships are estimated using robust regression techniques.

13. The program storage device as claimed in claim 8, wherein the historical data comprises data relating to business transactions, and supplementary data relating to external factors.

14. A computer system comprising:
a processor for executing software instructions;
a memory for storing software instructions;
a system bus coupling the memory and the processor; and
a storage medium recording software instructions that are loadable to the memory for implementing a method for identifying survey objectives, said method comprising:
estimating parameters of relationships between variables of historical data, wherein each relationship relates at least one observable variable to at least one controllable variable;
computing, for each of the relationships, a metric representing a degree of departure between values of said historical data and corresponding values predicted by said estimated parameters of the relationship;
ranking each of the relationships based upon the computed metric representing the degree of departure of the values of the historical data and the corresponding values predicted by the estimated parameters of the relationship; and
identifying at least one survey objective based upon the controllable and observed variables of the ranked relationships.

15. The computer system as claimed in claim 14, wherein said relationship further includes at least one user specified relationships.

16. The computer system as claimed in claim 14, wherein the metric for each of the relationships is computed based upon a scoring function that represents a sum-of-squares error between the historical data and the corresponding values.

17. The computer system as claimed in claim 16, wherein said method further comprises ranking the relationships based upon the relative values of computed metrics.

18. The computer system as claimed in claim 14, wherein the estimated parameters of the relationships are estimated using robust regression techniques.

19. The computer system as claimed in claim 14, wherein the historical data comprises data relating to business transactions, and supplementary data relating to external factors.
